(19) United States
(12) Patent Application Publication
(10) Pub. No.: US 2024/0079838 A1
(43) Pub. Date: Mar. 7, 2024

(54) MC4 Connector Opener Tool

(71) Applicant: Solaredge Technologies Ltd., Herzeliya (IL)

(72) Inventor: Meir Dahan, Ramat Gan (IL)

(21) Appl. No.: 18/459,575

(22) Filed: Sep. 1, 2023

Related U.S. Application Data
(60) Provisional application No. 63/403,762, filed on Sep. 4, 2022.

(51) Int. Cl. H01R 43/26

(52) U.S. Cl. CPC H01R 43/26

(57) ABSTRACT

Systems methods and apparatuses are disclosed herein for disconnecting MC4 connectors via a tool. The tool may comprise a holding portion and two arms. The two arms may be configured to align the tool for MC4 disconnection. The two arms may further be configured to squeeze anchoring tabs of connected MC4 connectors. Further, the two arms may be configured to extract and/or separate the connected MC4 connectors while holding the anchoring tabs in the squeezed position.

### CROSS-REFERENCE TO RELATED APPLICATIONS

This application claims priority to provisional U.S. Application No. 63/403,762 filed on Sep. 4, 2022, the contents of which are incorporated herein by reference in their entirety.

### FIELD OF THE INVENTION

The present invention relates to the field of connector opener tools and, more particularly, to the field of MC4 connector opener and/or disconnect tools.

### BACKGROUND OF THE INVENTION

MC4 connectors are known and are used in the solar panel industry to safely and reliably connect electrical wires. Each pair of connectors comprise a male MC4 connector (or: male connector) and a female MC4 connector (or: female connector). The MC4 connectors are named by their housing and not by their connecting plate since the male MC4 connector has a female connecting plate, and the female MC4 connector has a male connecting plate.

The male connector is provided with two anchoring tabs, and the female connector is provided with grooves that may house therein the anchoring tabs. In order to connect the male connector with the female connector, first, they are axially aligned. Then, they are brought one toward the other. At a first stage, the male connecting plate of the female connector slidingly enters into the female connecting plate of the male connector. At a second stage, when the male connecting plate is fully inserted, up to a required maximal depth, into the female connecting plate, then, the anchoring tabs snap into a free extended position within the corresponding grooves formed in the housing of the female connector. In this position, rear shoulders of the anchoring tabs abut against front shoulders of the grooves, thus locking the anchoring tabs in place and preventing the male connector and the female connector from being axially extracted from each other.

Solar panel installers often have to connect and disconnect many MC4 connectors, which can be tiresome and fatiguing.

### SUMMARY

The following summary presents a simplified summary of certain features. The summary is not an extensive overview and is not intended to identify key or critical elements.

Systems, apparatuses, and methods are described for unlocking and extracting and/or separating connected male and female MC4 connectors. The unlocking and extracting may be achieved via an opener tool. The unlocking and extracting may be achieved with a single motion. The opener tool may include features to align the tool in reference to the connected MC4 connectors for unlocking and extraction. The opener tool may include additional features to unlock the connected MC4 connectors. Additionally, the opener tool may include features to extract and or separate the connected MC4 connectors while maintaining the connectors in the unlocked position.

These and other features and advantages are described in greater detail below.

### BRIEF DESCRIPTION OF THE DRAWINGS

Some features are shown by way of example, and not by limitation, in the accompanying drawings.

FIG. 1 is a picture of a male connector and a female connector.

FIG. 2 is a side view of a male connector and a female connector.

FIG. 3 is a side picture of an assembled connector.

FIG. 4 is a side picture of a disassembled connector.

FIG. 5 is a side cross-sectional view of a disassembled connector.

FIG. 6 is a side cross-sectional view of an assembled connector.

FIG. 7 depicts an example MC4 connector opener tool.

FIG. 8 depicts an example opener tool engaging a male connector and a female connector.

FIG. 9 depicts a simplified cross-section view of an example cut-out of the arms of an example opener tool engaging the connectors.

FIG. 10 depicts an alternative example of an opener tool.

FIG. 11 depicts an alternative example of an opener tool.

FIG. 12 depicts an alternative example of an opener tool.

FIG. 13 depicts an alternative example of an opener tool.

FIG. 14 depicts an alternative example of an opener tool.

### DETAILED DESCRIPTION

The below described MC4 connector opener tool may press radially inwardly on the anchoring tabs of an MC4 connector and simultaneously push and move the male connector axially outwardly from the female connector.

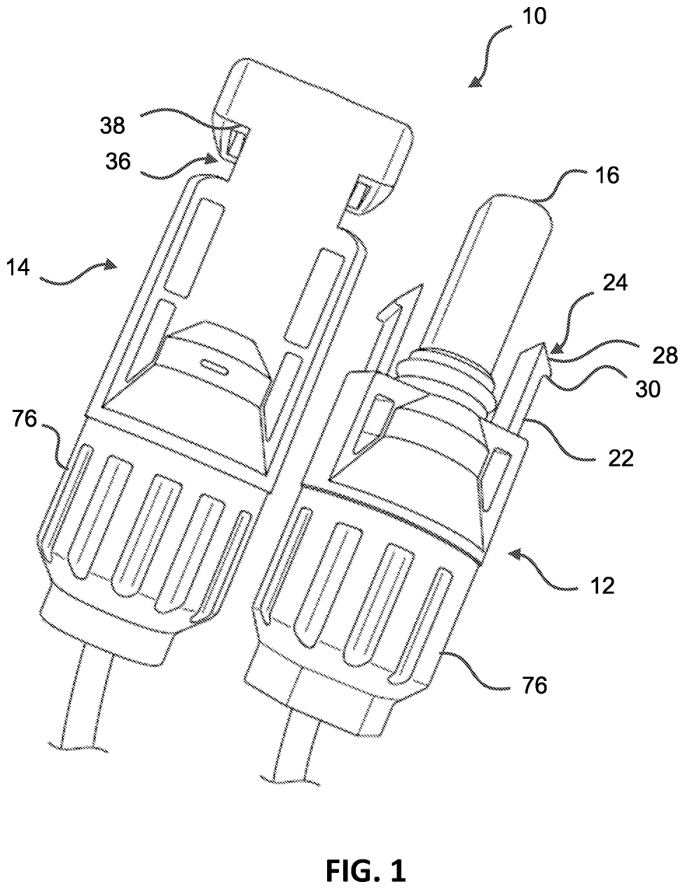

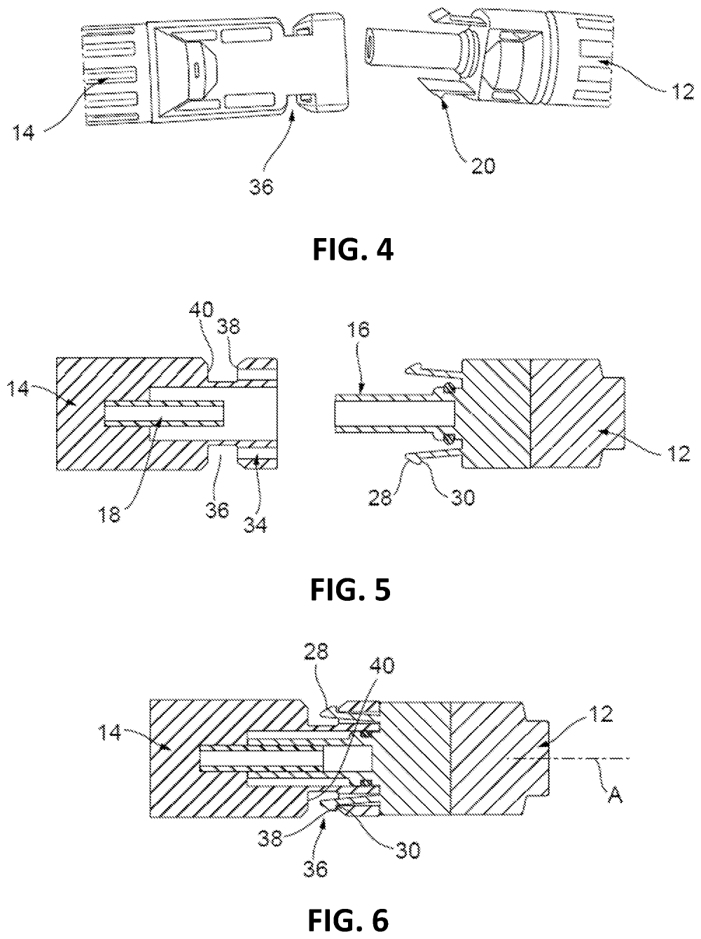

Referring to FIGS. 1 to 6. As shown, a standard MC4 connector 10 may comprise a male connector 12 and a female connector 14. The male connector 12 may comprise a female connecting plate 16, and the female connector 14 may comprise a male connecting plate 18.

The male connector 12 may comprise two anchoring tabs 20 located peripherally opposite from each other. In a free extended position, the anchoring tabs 20 may slightly diverge in a forward direction in order to provide adequate elasticity for the locking action as described herein. Each anchoring tab 20 may comprise an elastic prong 22. Each prong 22 may end with a wedge 24 in a front portion 26 thereof. The wedge 24 may comprise a sliding surface 28. The sliding surface 28 may be slanted forwardly and radially inwardly. The wedge 24 may also comprise a rearwardly facing rear shoulder 30, being a rear shoulder of an anchoring tab 20. The shoulder 30 may be directed substantially perpendicular to a longitudinal axis A of the male connector 12.

In order to connect and/or lock the male connector 12 with the female connector 14, they may first be axially aligned along the mutual longitudinal axis A. Then, they may be brought together toward each other. The male connecting plate 18 of the female connector 14 may slidingly enter into the female connecting plate 16 of the male connector 12. During that motion, each of the anchoring tabs 20 may be slightly bent radially inwardly (e.g., elastically deflected) by a peripheral wall 32 of a tab leading duct 34 of the female connector 14.

If the male connecting plate 18 is fully inserted, for example, up to a required maximal depth into the female connecting plate 16, then the anchoring tabs 20 end their travel within the tab-leading duct 34 and snap into a free extended position within lock grooves 36 formed in the housing of the female connector 14. Each of the lock grooves 36 may comprise a front shoulder 38, in which the tab-leading duct 34 opens thereinto, and a rear shoulder 40, parallel to the front shoulder 38 and spaced away rearwardly therefrom. In this position (e.g., the connected and/or locked position), the rear shoulders 30 of the anchoring tabs 20 may abut against the front shoulders 38 of the lock grooves 36, thereby locking the anchoring tabs 20 in place and preventing the male connector 12 and the female connector 14 from being axially extracted from each other (e.g., disconnected).

In order to disconnect the male connector 12 from the female connector 14, the anchoring tabs 20 may be radially inwardly pressed one toward the other, either manually by, for example, two fingers, until the rear shoulders 30 of the anchoring tabs 20 are released from the front shoulders 38 of the lock grooves 36. In this position, the male connector 12 may be firmly held by one hand, the female connector may be firmly held by another hand, and the male connector 12 may be slidingly pulled axially away from the female connector 14.

However, solar installation installers may be required to connect and/or disconnect many MC4 connectors 10. Releasing the anchoring tabs 20 from the lock grooves 36 for many MC4 connectors may prove tiresome, laborious, and/or time-consuming. Further, the MC4 connectors 10 of a solar installation may be disposed in difficult-to-reach places and positions. Accordingly, releasing the anchoring tabs 20 while trying to separate the male and female connectors 12 and 14 may prove exceedingly difficult and frustrating. Accordingly, an improved tool for releasing the anchoring tabs 20 and separating the male connector 12 from the female connector 14 is described herein. Many advantages of the presently described MC4 disconnector tool (e.g., opener tool) are described herein and will be understood with the benefit of the present description.

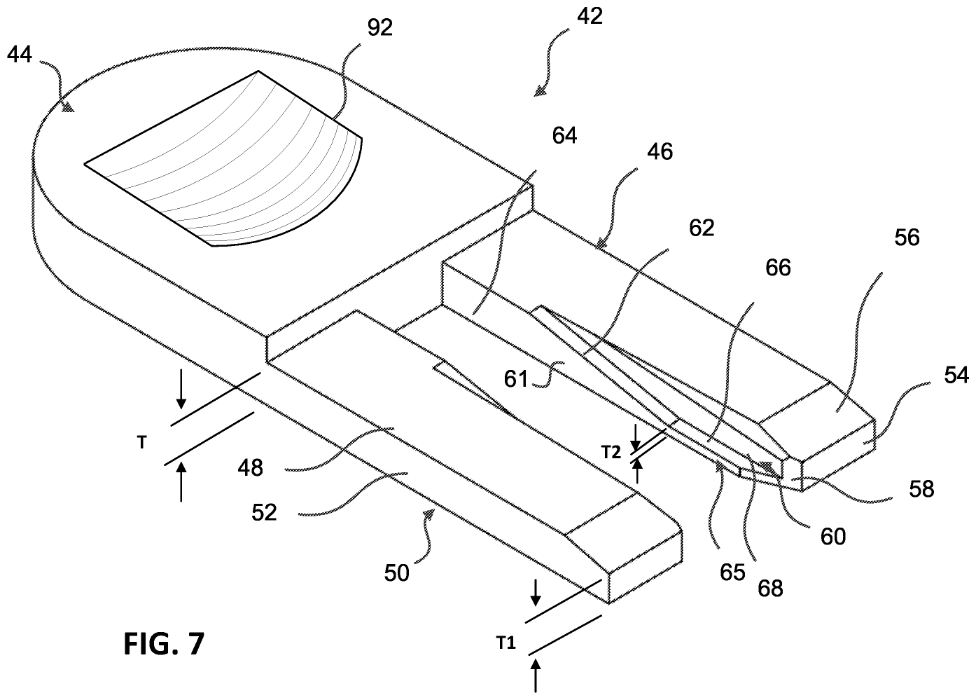

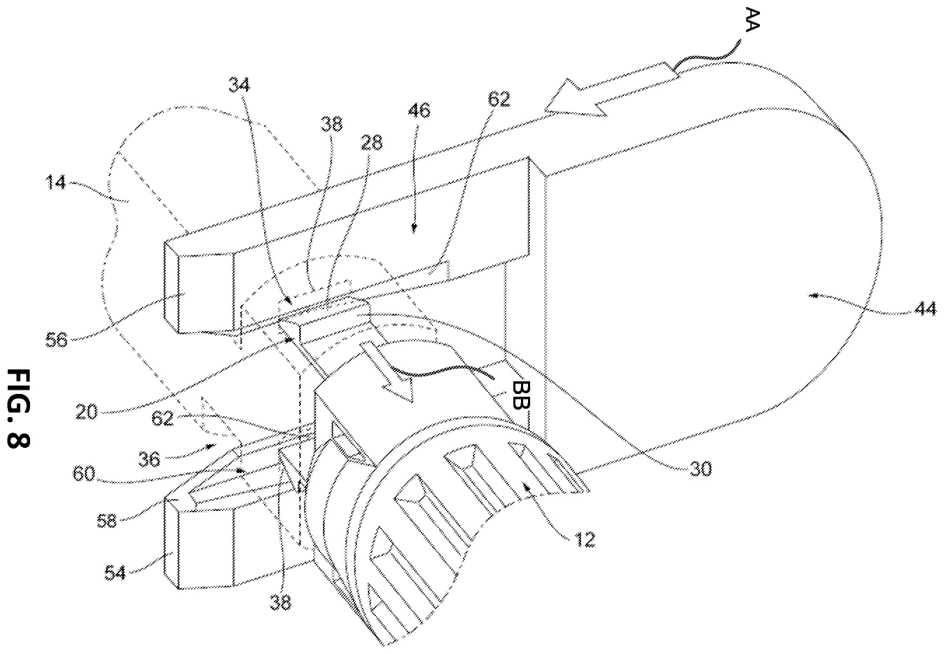

In order to disconnect (e.g., dismantle) the male connector 12 from the female connector 14, an improved MC4 connector opener tool 42 (e.g., opener tool, disconnect tool) apparatus is described herein. Additionally, an improved method for disconnecting MC4 connectors is described herein. FIG. 7 depicts an example MC4 connector opener tool 42. Referring to FIG. 7, the opener tool 42 may comprise a generally U-shape. The opener tool 42 may also comprise a base which may comprise a holding portion 44. The holding portion 44 may comprise features to assist gripping of the tool by a hand. For example, the holding portion 44 may comprise an indent 92. The indent 92 may comprise a depression in a surface of the holding portion 44. The indent 92 may be shaped and/or configured to accept and/or correspond to the thumb of a human hand. The indent 92 may additionally comprise etching, roughing, and/or other features to assist gripping and use of the opener tool 42. For example, the etching and/or roughing may increase cause an increase to a frictional force between a user's finger and the opener tool 42. Accordingly, the user may have added control over the opener tool 42 by virtue of the indent 92, the etching, and/or the roughing. Additionally or alternatively, the holding portion 44 may be variously configured and/or shaped. For example, FIG. 7 depicts the holding portion 44 as having a regular shape. Additionally or alternatively, the holding portion 44 may comprise an irregular shape. For example, the holding portion 44 may be shaped to the wrapped hand of a human.

The opener tool 42 may further comprise two arms 46 extending away from the holding portion 44. The two arms 46 may be parallel (or substantially) parallel to each other. The two arms 46 may be substantially similar to each other. The two arms 46 may be substantially mirror images of each other. The holding portion 44 may comprise a base and/or a tab. Each arm 46 may comprise an upper surface 48 and a lower surface 50. The upper surface 48 and lower surface 50 may be substantially parallel to each other. Each arm 46 may additionally comprise two sides, an inner side 64 and an outer side 52 extending between the upper surface 48 and the lower surface 50. The distance between the upper surface 48 and the lower surface 50 may define a thickness T of the arm 46. The thickness T of the arms 46 may be such that they fit within the lock grooves 36. In some configurations, the thickness T may be about the distance between the front shoulder 38 and rear shoulder 40 of the lock groove.

Each arm 46 may also comprise, at a front end 54 thereof, an insertion surface 56. The insertion surface may extend between the outer side 52 of the arm 46 and the inner side 64 of the arm 46. Additionally, the insertion surface 56 may extend from the front end 54 of the arm 46 rearwardly for a predefined distance. At its rearmost portion, the insertion surface 56 may terminate at the upper surface 48. From its termination extending forwardly, the insertion surface 56 may be slanted forwardly from the upper surface 48 toward the lower surface 50 of the arm 46. Accordingly, the thickness of the arm 46 may be reduced at its front end 54 (e.g., via the insertion surface 56), such that the thickness of the arm front end T1 may be smaller than the thickness T of the rest of the arm 46. From its start extending rearward, the insertion surface 48 may start at a thickness T1 that is less than the thickness T, and extend rearwardly and upwardly (e.g., sloped, slanted, and/or tapered) and terminate at the upper surface 48. Accordingly, the insertion surface 56 may act as a guide and may enable quick and easy insertion of the arms 46 into the lock grooves 36 of the female connector 14. The arms 46 may be at least partially aligned and/or guided upon insertion into the lock grooves 36 by the insertion surface. Although the insertion surface 56 is depicted as a slanted surface, other configurations (e.g., a curved surface) are anticipated.

The inner side 64 of each arm 46 (e.g., facing the other arm 46) may comprise a pressing surface 58. The pressing surface may be slanted inwardly (e.g., toward the other arm 46) and rearwardly with respect to the arm front end 54. The pressing surface 58 may be slanted inward with respect to the opener tool 42 (e.g., the pressing surface 58 of each arm may extend toward the middle of the opener tool 42) but may be slanted outward with respect to each individual arm 46 (e.g., the pressing surface 58 may increase the width of the arm 46 as it extends rearwardly). Accordingly each arm 46 may taper from its front end 54 in thickness (e.g., via the insertion surface 56) and in width (e.g., via the pressing surface 58).

If the arms 46 are inserted into the lock grooves 36 of the female connector 14, upon insertion, the pressing surface 58 of each arm 46 may press radially inwardly against the sliding surface 28 of its adjacent wedge 24. During this stage, and based on the force asserted by the pressing surface 58, the anchoring tabs 20 may be radially inwardly pressed, one toward the other, until the rear shoulders 30 of the anchoring tabs 20 are released from the front shoulders 38 of the lock grooves 36. Although the pressing surface 58 is depicted as slanted, other configurations (e.g., a rounded surface) are contemplated.

The inner side 64 of each arm 46 (e.g., facing the other arm) may comprise a cut-out 60. The cut-out 60 may extend rearwardly from the front end 54 of the arm 46 (and/or from the termination of the pressing surface 58). The cut-out 60 may terminate in the proximity of the holding portion 44. Additionally or alternatively, the cut-out 60 may end a predefined distance forwardly from the holding portion 44. The cut-out 60 may comprise a holding surface 68. The holding surface 68 may start at the termination of the pressing surface 58. The holding surface 68 may be proximate to and/or adjacent to the pressing surface 58. The holding surface 68 may be configured as a wall. The holding surface 68 may be substantially flat. The holding surface 68 may be substantially perpendicular to the upper surface 48. Alternatively, the holding surface 68 may be substantially angled (e.g., complementarily angled with respect to the sliding surface 28. In use, the holding surface 68 of each of the two arms 46 may be sufficiently distanced from each other to hold (e.g., by squeezing) the two anchoring tabs 20 of the male connector 12 in the unlocked and/or released position.

The cut-out 60 may comprise a first portion and a second portion. The first portion may comprise a forwardmost portion. The first portion may comprise an alignment portion 65. The alignment portion 65 may comprise an alignment surface 66. The alignment surface 66 may be distanced from the lower surface 50 of the arm 46 by thickness T2. In some configurations, the thickness T2 may be about the distance between the underside of the wedge 24 and the rear shoulder 40, for example, if a male connector 12 and a female connector 14 are connected. The alignment surface 66 may be substantially flat. The alignment surface may be substantially parallel to the bottom surface 50 (and/or the top surface 48). The alignment surface 66 (and the alignment portion 65) may extend from the start of the cut-out 60 (e.g., at the termination of the pressing surface 58) and extend rearwardly for a predetermined distance. If the arms 46 are inserted into the lock grooves 36 of the female connector 14 (e.g., as depicted in FIG. 8), the alignment surface 66 may slide underneath the wedges 24 of the anchoring tabs 20. Accordingly, the alignment portion 65 of the cut-out 60 may slide between the tops (e.g., the points) of the wedges 24 and the rear shoulder 40 of the lock groove 36. Thus, upon insertion, the alignment portion 65 may assist the user in aligning the arms 46 and/or opener tool 42 in the proper location for extraction. Additionally, a front portion of the alignment surface 66 may be slanted inward and rearward. The slant of the front portion of the alignment surface may follow (e.g., continue) the slant of the pressing surface 58. This slanted portion may render it easier for the alignment portion 65 (and alignment surface 66) to slide under the wedge 24 of an adjacent anchoring tab 20 by decreasing the abruptness of the transition into the alignment portion 65 and the alignment surface 66.

The cut-out 60, at the second portion thereof, may further comprise an extraction portion 61. The extraction portion 61 may comprise an extraction surface 62. The extraction surface 62 may begin proximate to the termination of the alignment surface 66. The extraction portion 61 may be wedge-shaped and/or tapered. The extraction surface 62 may be variably spaced from the lower surface 50. At its start, the extraction surface 62 may be disposed at a distance T2 from the lower surface. The extraction surface 62 may extend rearwardly and upwardly. The extraction surface 62 may extend up to the upper surface 48 of the arm 46. The extraction portion 61, the extraction surface 62 and/or the cut-out 60 may terminate at the end of the extraction surface 62 where the extraction surface 62 may join the upper surface 48. At its termination, the extraction portion 61 may have a thickness that is substantially the thickness T of the arm 46.

FIG. 8 depicts an example opener tool 42 engaging a male connector 12 and a female connector 14. Referring to FIG. 8, the opener tool may engage the connectors 12 and 14 in multiple stages. At stage one, the insertion surface 56 of the arms 46 of the opener tool 42 may be inserted into the lock grooves 36 of the female connector 14 in the direction of the arrow AA. At this stage, the insertion surface 56 may guide the arms 46 into the lock grooves 36, easing the use of the tool for an installer. Further, at stage one, the pressing surface 58 may engage and/or begin pressing against an adjacent sliding surface 28 of an adjacent wedge 24 (of an anchoring tab 20). At stage two, the arms 46 may be continuously inserted (e.g., in the direction AA) into the lock grooves 36 of the female connector 14. As the tool continuously slides into the lock grooves 36, at stage two, due to the slant of the pressing surfaces 58 of each arm 46, the distance between the two pressing surfaces 58 may narrow. Additionally, due to the slant of the pressing surface 58 of each of the arms 46, at stage two, the pressing surface 58 may continue to assert a force on the anchoring tabs 20, deflecting the anchoring tabs 20 from their free extended position. The force asserted on the anchoring tabs 20 and wedges 24 (e.g., by the pressing surface 58) may squeeze the anchoring tabs 20 (e.g., press the anchoring tabs 20 radially inwardly) and cause the anchoring tabs 20 to unlock and/or release from their locked position. For example, at stage two, the pressing force of the pressing surface 58 on an adjacent wedge 24 of the anchoring tab 20 (e.g., via the adjacent sliding surface 28) may cause the rear shoulder 30 of the wedge 24 to disengage, unlock, and/or release from the front shoulder 38 of the lock groove 36.

At stage three, as the opener tool 42 is continually inserted into lock groove 36 of the female connector 14 (e.g., in the direction of the arrow AA), the cut-out 60 may engage the connectors 12 and 14. Beyond the pressing surface 58, the holding surface 68 of the cut-out 60 may continue to exert a force on (e.g., squeeze) an adjacent anchoring tab 20 via its wedge 24 (and sliding surface 28). In this manner, the holding surface 68 of the cut-out 60 may hold the adjacent anchoring tab 20 in the released and/or unlocked position. If the sliding surface 28 of the wedges 24 of the anchoring tabs 20 are pressed against the holding surface 68 of the cut-out 60, the male connector 12 and female connector 14 may be ready for separation (e.g., by pulling the two connectors 12 and 14 axially away from each other).

Additionally, at stage three, the alignment surface 66 of the cut-out 60 may slide underneath the wedges 24 of the anchoring tabs 20. Accordingly, the alignment surface 66 of the cut-out 60 of each of the arms 46 may slide between a proximate and/or adjacent wedge 24 of the male connector 12 and a proximate and/or adjacent rear shoulder 40 of the female connector 14. At this stage, the tool may be held in place by the interaction of (e.g., the forces) of the various features of the cut-out 60 (e.g., the holding surface 68 and the alignment surface 66) with the various surfaces of the connectors 12 and 14.

At stage four, the opener tool 42 may be continuously inserted into the lock grooves 36 in the direction of the arrow AA, and the extraction surface 62 may engage an adjacent wedge 24, for example, at an underside thereof. At this stage, the anchoring tabs 20 may be released from the front shoulders 38 of the lock grooves 36 (as described above). Thus, the continual insertion of the arms 46 into the lock grooves 36 may cause the extraction surface 62 to begin extracting the male connector 12 from the female connector 14. The extraction surface 62 may cause extraction of the connectors 12 and 14 by pushing the male connector 12 in the direction of the arrow BB. This extraction may be caused and/or precipitated by a wedging effect created by the extraction surface 62 and the lower surface 50 of the arm 46, exerting forces against the sliding surface 28 and or the underside of the wedge 24 and the rear shoulder 40 of the lock groove 36. If the arms 46 of the opener tool 42 are continually inserted, the taper and/or increasing thickness of the extraction surface may cause the female connecter 14 and the male connector 12 to be continually extracted and separated from each other.

The opener tool 42 produced and/or manufactured using various materials and production techniques. For example the opener tool 42 may be produced from polymers, for example, various plastics. If the opener tool 42 is produced from a polymer material, the opener tool 42 may be injection molded, compression molded, 3D printed, etc. Additionally or alternatively, the opener may be produced from various metals (e.g., aluminum, steel, copper brass, alloys, etc.). Opener tools 42 produced from metal may be, for example, casted (e.g., sand casted, die casted, etc.), machined (e.g., milled, CNC machined), formed (e.g., stamped), additively produced (e.g., 3D printed), etc.

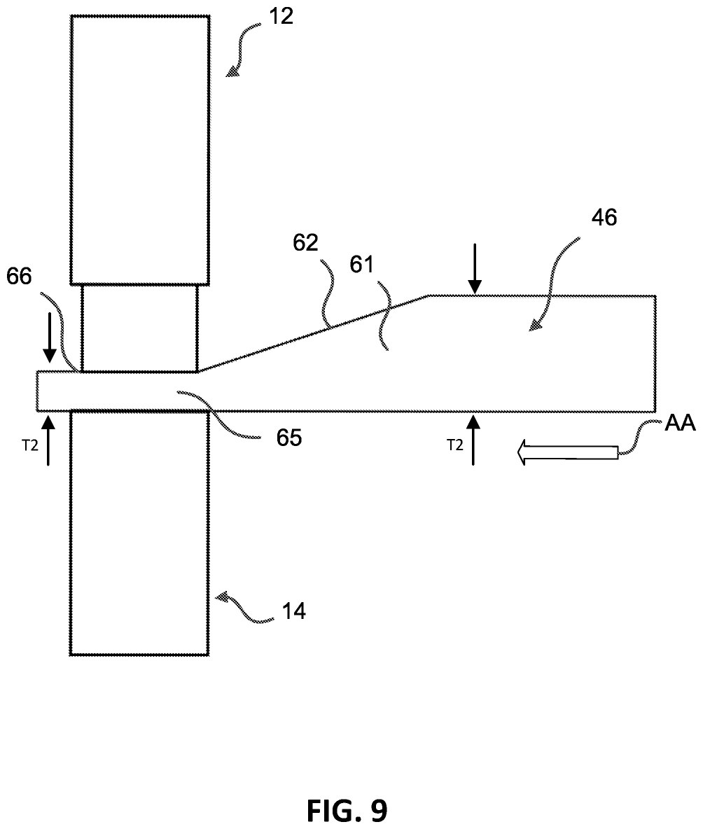

FIG. 9 depicts a simplified cross-section view of an example cut-out 60 of the arms 46 of an example opener tool 42 engaging the connectors 12 and 14. Referring to FIG. 9, the alignment surface 66 may be positioned between the underside of the wedge 24 of the anchoring tab 20 and the rear shoulder 40 of the lock groove 36. As the opener tool 42 is slid in the direction of the arrow AA, the increased thickness from T2 to T of the extraction portion 61 may cause the separation of the connectors 12 and 14 by pushing against the wedge 24 and the rear shoulder 40.

In this manner, by a single insertion of the arms 46 of the opener tool 42 into the lock grooves 36 of the female connector 14, at least two actions may be done; first, the anchoring tabs 20 of the male connector 12 may be pressed radially inwardly until they are released from their locking position, and, second, the male connector 12 may be extracted axially outwardly from the female connector 14. Additionally, the configuration of the arms 46 and the cut-outs 60 may act as a guide for the opener tool 42 to be aligned and retained in its position during disconnection. Thus, by a single motion of the opener tool 42, the opener tool 42 may be properly aligned for disconnection, and the male connector 12 may be extracted from the female connector 14. Thus, by initially acting as a guide, the opener tool 42 may reduce the used fine motor skill of the user to place the opener tool 42 in position for extraction. Subsequently, if the opener tool 42 is aligned and held in place in engagement with the connectors 12 and 14, the user may simply push the opener tool 42 the remainder of the way to extract the connectors. Thereby, the opener tool 42 eases the fine motor skill requirement of the user. Such improvements are generally advantageous, and especially advantageous if the opener tool 42 is being used in tight and/or hard-to-reach places.

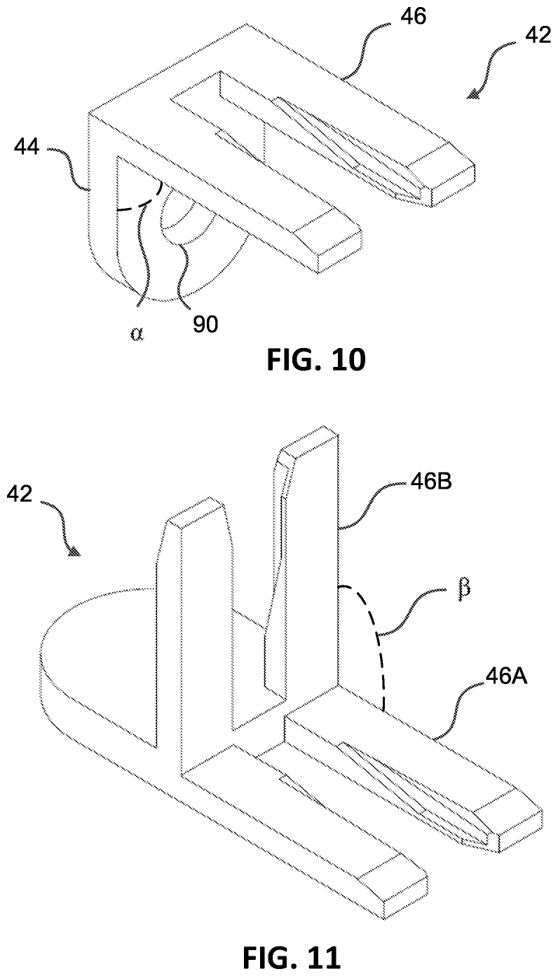

FIGS. 7-8 depict example opener tools 42 wherein the arms 46 are substantially in line with (e.g., 1800 from) the holding portion 44. FIG. 10 depicts an alternative example of an opener tool 42. Referring to FIG. 10, the holding portion 44 and the arms 46 may be angled with respect to each other. For example, the arms 46 may extend at an angle α from the holding portion 44. FIG. 10 depicts an opener tool 42 having an example angle α of about 90°. Alternatively, the arms 46 may extend from the holding portion at a different angle α (e.g., 135°). The opener tool 42 may also comprise a hole 90, for example, in the holding portion 44. The hole 90 may be used, for example, to attach the opener tool 42 to a key ring and/or key chain.

FIGS. 7-8 depict example opener tools 42 having a single pair of arms 46. FIG. 11 depicts an alternative example of an opener tool 42. Referring to FIG. 11, the opener tool 42 may comprise a plurality of (e.g., two) pairs of arms 46A and 46B (generally, arms 46). The plurality of pairs of arms 46 may be substantially identically configured or may be configured differently. Accordingly, a single opener tool 42 may afford a user multiple positions for use. The different pairs of arms 46 may be offset from each other by a predefined angle β. FIG. 11 depicts the predefined angle β as substantially 90°. The disclosure should not be so limited, however, and other predefined angles β (e.g., 135°) are contemplated.

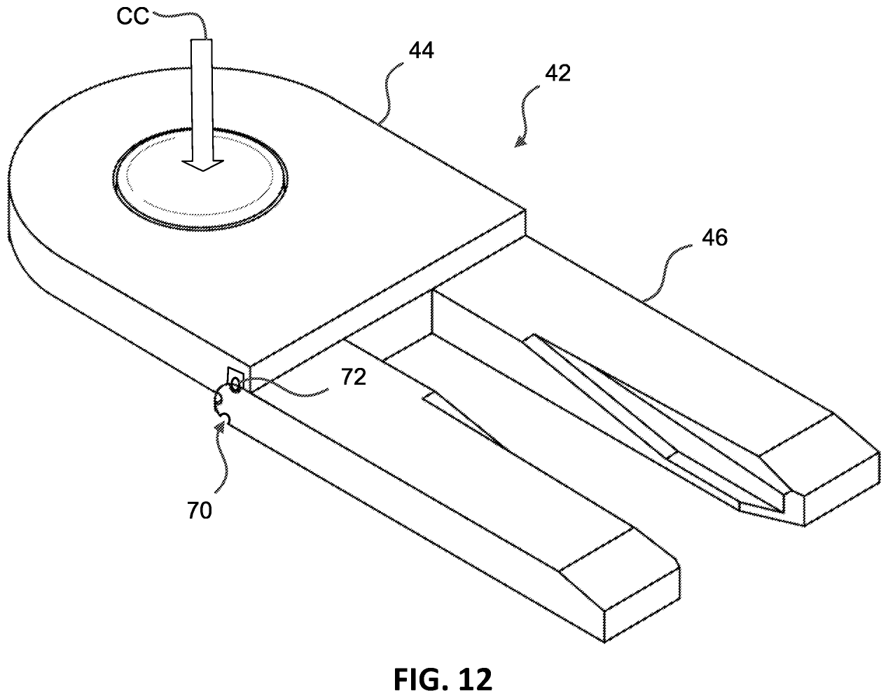

FIGS. 7-8 depict example opener tools having arms 46 in a fixed position relative to the holding portion 44. FIG. 12 depicts an alternative example of an opener tool 42. Referring to FIG. 12, the position of the arms 46 may be adjustable. Additionally or alternatively, the arms 46 may be foldable (e.g., for storage). The arms 46 may be rotatably coupled to the holding portion 44. Accordingly, the arms 46 may be rotated, for example, between about 0° and about 180° from the holding portion 44. Additionally, the opener tool 42 may be configured to lock the arms 46 in various positions.

The arms 46 may be rounded, for example, at a rear portion thereof. The rounded portion of the arms 46 may be proximate to a connection point with the holding portion 44. The arms 46 may be rotatably mated with the holding portion 44. The arms 46 may comprise one or more detents 70 in the rounded portions. The one or more detents 70 may be configured to accept, for example, a lock bar 72 of, for example, substantially complementary geometry. The lock bar 72 may be, for example, spring-loaded. If one of the plurality of detents 70 is aligned with the lock bar, the spring load on the lock bar 72 may force the lock bar 72 in the direction of and into the aligned detent 70. The lock bar 72 may be pushed into and held into the detent 70, thereby locking the rotation of the arms 46. The arms may be locked in different positions and orientations with the different one of the plurality of detents 70.

The lock bar 72 may be released from the detents 70, and the arms 46 may be rotated. For example, the opener tool 42 may further comprise a lock bar release 74. The lock bar release may be configured as a button disposed in the holding portion 44. The lock bar release 74 may be depressed (e.g., substantially in the direction of arrow CC), which may cause the lock bar 72 to be removed from the detent 70. Thus, the rotation of the arms 46 may be unlocked, and the arms 46 may be rotated. If the lock bar release 73 is released (e.g., not depressed), the lock bar 72 may be forced (e.g., as caused by a spring load) in the direction of the arms 46. Accordingly, if the arms 46 are rotated, and a detent 70 aligns with the lock bar 72, the lock bar 72 may be forced into the detent 70, locking the arms 46 in a position. With this configuration, the opener tool 42 may be foldable for storage and may allow for a plurality of positions for use depending on the particular detent 70 used to lock the rotation of the arms 46 relative to the holding portion 44.

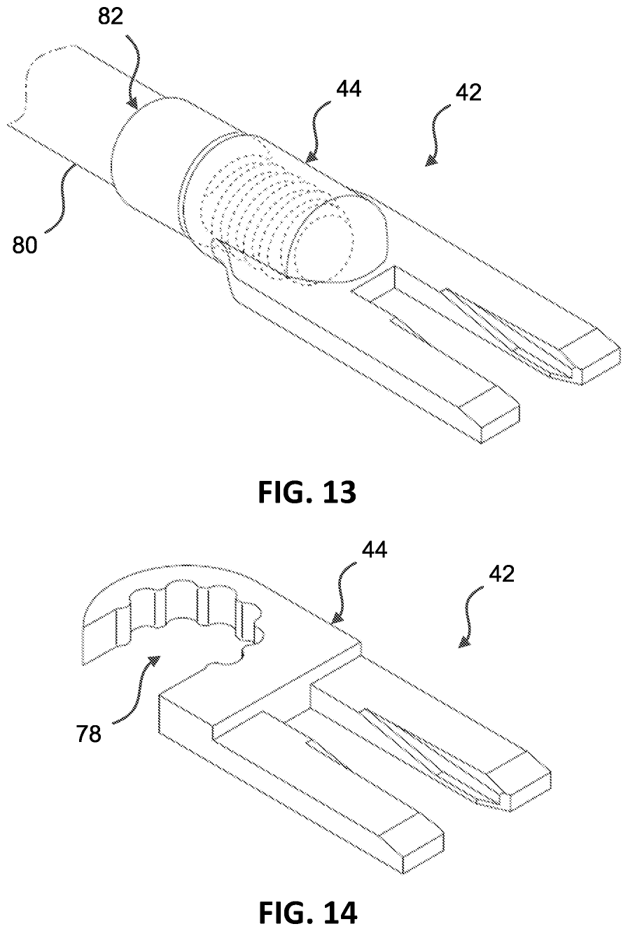

FIG. 13 depicts an alternative example of an opener tool 42. Referring to FIG. 13, the opener tool 42 may extend from and or be attached to a pole or a rod 80. The pole and/or rod 80 may be extendable. The pole and/or rod 80 may be attachable and detachable, for example, via a threaded termination, from the opener tool 42. For example, the holding portion 44 of the opener tool 42 may be complementarily threaded with the termination of the pole and/or rod 80. In this manner, the user may use the extendable rod and/or pole to reach disconnect connectors in otherwise difficult-to-reach spaces.

The holding portion 44 of the opener tool 42 may comprise a connection point at which the rod 80 may be attached to the opener tool 42. The connection point may comprise a receptacle 82. The receptacle 82 may be threaded. Although FIG. 13 depicts the holding portion as comprising a receiving portion (e.g., the receptacle) and the rod 80 as comprising the insertion portion, the opposite configuration is also contemplated. The example configuration of FIG. 13 depicts the opener tool 42 and the extension rod 80 as separable. Alternatively, the opener tool 42 and extension rod 80 may be integrally formed (e.g., not separable).

In view of the present disclosure, another advantage of the opener tool 42 may be understood. The opener tool 42 comprises guiding and aligning features as described above. Further, the opener tool 42 also comprises extraction features, as described above. Accordingly, the tool may be used on an extension and/or in difficult-to-reach places with minimal use of, or without the use of, a user's hands on the connectors 12 and/or 14.

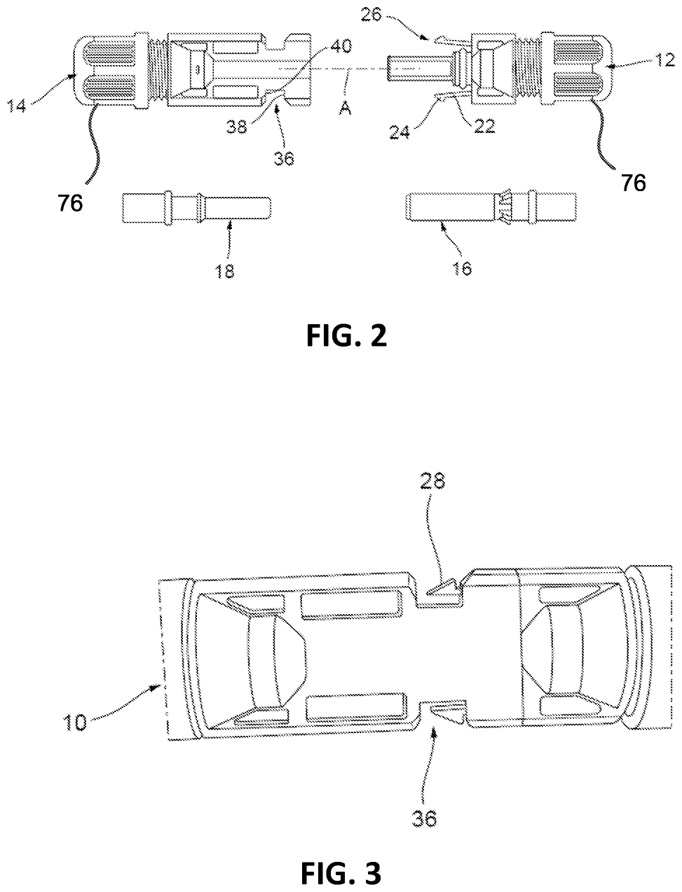

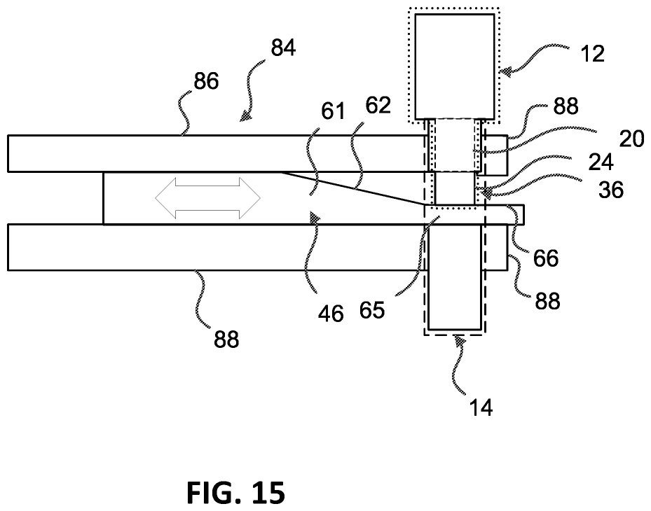

Referring back to FIGS. 1 and 2, the male connector 12 and/or the female connector 14 may comprise terminal covers 76. The terminal covers 76 may be screwed down onto the remainder of the connectors 12 and 14. FIG. 14 depicts an alternative example of an opener tool 42. Referring to FIG. 14, the opener tool 42 may comprise additional tools for use with MC4 connectors 10. For example, the holding portion 44 may be configured as a wrench or spanner 78. The spanner 78 may be geometrically configured to grip the terminal covers 76. Accordingly, the opener tool 42 may double as a spanner to tighten and/or loosen the terminal covers 76.

Considering the advantages described above, additional utility and advantages may be achieved using the opener tool 42. FIG. 15 depicts an example actuated opener tool 84 (the actuated opener tool 84 may be similar to the opener tool 42 in all respects except as explicitly described herein). The actuated opener tool 84 may comprise limbs 86. The limbs 86 may terminate in fingers 88. The fingers may be configured to wrap around and/or butt up against the female connector 14 (depicted as enclosed by the dashed line in FIG. 15) and/or the male connector 12 (depicted as enclosed by the dotted line in FIG. 15) of a connected MC4 connector pair.

The actuated opener tool 84 may further comprise arms 46. Arms 46 may be substantially similar to the arms 46 of the opener tool 42 described above. The arms 46 may be disposed between the limbs 86. The arms 46 may be disposed in a sliding relationship with the limbs 86. FIG. 15 depicts a cross-section of the arms 46 showing the alignment portion 65 and alignment surface 66, and the extraction portion 61 and extraction surface 62.

The arms 46 may slide in the direction of the arrows depicted in FIG. 15. The sliding action of the arms 46 may be actuated by a user of the actuated opener tool 84. In different configurations, different user actions may actuate the arms 46. For example, the limbs 86 may be connected to an actuated opener tool 84 having squeezable handles. If a user squeezes (or in a different configuration releases) the handles of the actuated opener tool 84, the arms 46 may slide in the direction of the male and female connectors 12 and 14 (and the fingers 88). In an alternative configuration, the separation of two handles may cause the arms 46 to slide in the direction of the fingers 88. Additionally or alternatively, for example, following use, the arms 46 may be retracted from their actuated position.

The actuated opener tool 84 may be used as follows. The user may place the fingers 88 around connected female and male connectors 14 and 12. With the fingers around the connectors 12 and 14, the user may actuate the sliding action of the arms 46 (by, e.g., squeezing a pair of handles of the actuated opener tool 84). As the user actuates the actuated opener tool 84, the arms 46 may slide in the direction of the connected male and female connectors 12 and 14. As the arms slide 46 toward the fingers 88, the arms 46 may slide into the lock groove 36. If the arms enter the lock grooves 36 and engage the wedge of the anchoring tab 20, a force in the direction of the movement of the arms 46 (e.g., in the direction of the fingers 88) may be exerted on the connector pair. This force may be passed through the connectors 12 and 14 to the fingers 88 (e.g., wrapped around and/or butt up against the connectors 12 and/or 14). Without fingers 88, this force may push the connector pair away from the arms 46, not allowing the arms to engage the lock groove and unlock and extract the connectors. However, using the actuated opener tool 84, any force on the connectors 12 and 14 may be absorbed by the fingers 88. Accordingly, the arms 46 may slide through the lock groove 36, align the features within the lock groove 36 (as described above), and unlock and extract the connectors 12 and 14 (as described above). Following extraction, the arms 46 may be retracted (e.g., with an opposite user motion to that which caused extraction), and the actuated opener tool 84 may be ready for use to extract another male and female connector 12 and 14 pair. Thus the single motion align, unlock, and extraction as described herein may allow for additional beneficial tool configuration and methods of extraction and disconnection.

Although the actuated opener tool 84 is depicted as comprising two limbs 86 and two fingers 88, the present disclosure is not so limited. Rather, the actuated opener tool 84 may comprise any number of limbs 86 and/or fingers 88 (e.g., 1, 3, etc.).

Although examples are described above, features and/or steps of those examples me be combined, divided, omitted, rearranged, revised, and/or augmented in any desired manner. Various alterations, modifications, and improvements are intended to be part of this description, though not expressly stated herein, and are intended to be within the spirit and scope of the disclosure. Accordingly, the foregoing description is by way of example only, and is not limiting.

1. An apparatus comprising:
a base; and
two arms parallelly extending from the base, each arm of the two arms comprising:
an upper surface and an opposing lower surface; and
an outer side and an opposing inner side, each extending between the upper and lower surfaces, wherein the inner side comprises:
a pressing surface configured to press an anchoring tab of a male MC4 connector;
a cut-out comprising an extraction portion extending rearwardly and upwardly and configured to separate the male MC4 connector from a female MC4 connector.

2. The apparatus of claim 1, wherein each arm of the two arms further comprises an insertion surface at a front end of the arm, the insertion surface extending rearwardly and upwardly from the front end of the arm.

3. The apparatus of claim 1, wherein the pressing surface of each arm of the two arms begins proximate to a front end the arm and extends toward another of the two arms and rearwardly.

4. The apparatus of claim 1, wherein the cut-out comprises a portion of each of the arms having a decreased width.

5. The apparatus of claim 1, wherein the cut-out further comprises an alignment portion disposed at a front portion of the cut-out, the alignment portion having a substantially flat surface and having a first thickness that is less than a second thickness of the arm.

6. The apparatus of claim 5, wherein the substantially flat surface of the alignment portion is configured to slide underneath the anchoring tab of the male MC4 connector.

7. The apparatus of claim 1, wherein the extraction portion is wedge shaped.

8. The apparatus of claim 1, wherein the extraction portion is configured to apply a force to the anchoring tab of the male to separate the male MC4 connector and the female MC4 connector.

9. The apparatus of claim 1, wherein the cut-out further comprises a holding surface configured to apply a force to the anchoring tab of the male MC4 connector.

10. An apparatus comprising:
two substantially similar arms substantially parallelly disposed to one another, each arm of the two arms comprising:
a tapered pressing surface extending outward and rearward from a front of the arm; and
a cut-out comprising:
an alignment portion having a substantially flat surface; and
an extraction portion having a wedge shape.

11. The apparatus of claim 10, wherein each of the two arm extend from a base portion.

12. The apparatus of claim 10, wherein the tapered pressing surface is configured to apply a force to an anchoring tab of an MC4 connector.

13. The apparatus of claim 10, wherein each arm of the two arms further comprises a tapered portion extending upwardly and rearwardly from the front of the arm.

14. The apparatus of claim 10, wherein the alignment portion is configured to slide underneath an anchoring tab of an MC4 connector.

15. The apparatus of claim 10, wherein the extraction portion increases in thickness as it extends rearwardly.

16. An apparatus configured to disconnect a pair of two MC4 connectors comprising:
two substantially parallel arms comprising:
a first portion configured to squeeze tabs of one of the two MC4 connectors;
a second portion configured to:
hold the tabs in the squeezed position; and
separate the two MC4 connectors.

17. The apparatus of claim 16, wherein the first portion is configured to squeeze the tabs of the one of the two MC4 connectors via a tapered surface.

18. The apparatus of claim 16, wherein the first portion further comprises a tapered portion extending upward and rearward from a front of the arms.

19. The apparatus of claim 16, wherein the second portion further comprises a cut-out comprising a holding surface configured to hold the tabs in the squeezed position.

20. The apparatus of claim 16, wherein the second portion further comprises a wedge shaped extraction portion configured to separate the two MC4 connectors.
